(19) United States
(12) Patent Application Publication
(10) Pub. No.: US 2025/0166262 A1
(43) Pub. Date: May 22, 2025

(54) ALTERNATE REPLAYS OF HIGHLIGHTS FOR OUTCOME EXPLORATION

(71) Applicant: Samsung Electronics Co., Ltd., Suwon-si (KR)

(72) Inventors: Indranil Sinharoy, Richardson, TX (US); Saifeng Ni, Santa Clara, CA (US); Madhukar Budagavi, Plano, TX (US); Rajan Laxman Joshi, San Diego, CA (US)

(21) Appl. No.: 18/939,500

(22) Filed: Nov. 6, 2024

Related U.S. Application Data
(60) Provisional application No. 63/599,896, filed on Nov. 16, 2023.

(51) Int. Cl. G06T 11/60; G06T 7/20

(52) U.S. Cl. CPC G06T 11/60; G06T 7/20; G06T 2207/30241

(57) ABSTRACT

Methods and systems for user velocity tracking using wireless technology. A computer-implemented method includes receiving an input, receiving a video feed including a plurality of frames, selecting a subset of the plurality of frames based on the input, generating at least one alternate frame based on at least one original frame of the selected subset, replacing the at least one original frame in the selected subset with the at least one alternate frame to generate an altered video feed, and displaying the altered video feed on a display. An alternative replay generation system is configured receive a video feed including a plurality of frames, select a subset of the plurality of frames, generate at least one alternate frame based, and replace at least one original frame in the selected subset with the at least one alternate frame to generate an altered video feed.

### CROSS-REFERENCE TO RELATED APPLICATIONS AND CLAIM OF PRIORITY

The present application claims priority to U.S. Provisional Patent Application No. 63/599,896, filed on Nov. 16, 2023. The contents of the above-identified patent documents are incorporated herein by reference.

### TECHNICAL FIELD

The present disclosure relates generally to video processing systems. More specifically, the present disclosure relates to a system and method generating alternate replays of video feeds.

### BACKGROUND

The use of tracking and advanced visualization systems is increasing in various sports environments, particularly to track balls and players. These systems not only make on-field sports decision making less error-prone but also enable the sports analysts and broadcasters overlay various sports information and statistics in useful ways, thereby enhancing the experience for and increasing engagement of the viewers. However, visualization of “what if” scenarios, e.g., using an altered video feed, after each game may be particularly useful, though currently difficult to generate, as there are no systems to visualize and perceptually explore such alternative possible game-plays and outcomes.

Accordingly, there is a need for systems and methods for generating alternate replays of highlights for outcome exploration that overcome these challenges.

### SUMMARY

The present disclosure relates generally to video processing systems and, more specifically, the present disclosure relates to a system and method generating alternate replays of video feeds.

In one embodiment, a computer-implemented method is provided. The computer-implemented method includes receiving an input, receiving a video feed including a plurality of frames, selecting a subset of the plurality of frames based on the input, generating at least one alternate frame based on at least one original frame of the selected subset, replacing the at least one original frame in the selected subset with the at least one alternate frame to generate an altered video feed, and displaying the altered video feed on a display.

In another embodiment, an alternative replay generation system is provided. The alternative replay generation system includes an electronic device having a processor. The processor is configured to cause the electronic device to receive an input, receive a video feed including a plurality of frames, select a subset of the plurality of frames based on the input, generate at least one alternate frame based on at least one original frame of the selected subset, replace the at least one original frame in the selected subset with the at least one alternate frame to generate an altered video feed, and transmit the altered video feed to a display.

In yet another embodiment, a non-transitory computer-readable medium is provided. The non-transitory computer-readable medium includes program code, that when executed by at least one processor of an electronic device, causes the electronic device to receive an input, receive a video feed including a plurality of frames, select a subset of the plurality of frames based on the input, generate at least one alternate frame based on at least one original frame of the selected subset, replace the at least one original frame in the selected subset with the at least one alternate frame to generate an altered video feed, and transmit the altered video feed to a display.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example entertainment system according to various embodiments of the present disclosure;

FIG. 2 is a block diagram illustrating an electronic device in a network environment according to various embodiments;

FIG. 3 illustrates an example alternative replay generation system for use in an entertainment system according to various embodiments of the present disclosure;

FIG. 4 illustrates an example electronic device to support an entertainment system according to an embodiment of the present disclosure;

FIG. 5 illustrates an example input/output system for an alternative replay generation system as part of an entertainment system according to various embodiments of this disclosure;

FIG. 6 illustrates an example high-level data flow and block diagram of the alternative replay generation system according to an embodiment of the present disclosure;

FIG. 7 illustrates an example high-level data flow and block diagram of a multi-object tracking model used to support the alternative replay generation system according to an embodiment of the present disclosure;

FIG. 8 illustrates an example high-level data flow and block diagram of an alternative replay generation system according to an embodiment of the present disclosure;

FIG. 9 illustrates an example training model block diagram used to support an alternative replay generation system according to an embodiment of the present disclosure; and

FIG. 10 illustrates an example flow chart of a method of generating an altered video feed according to various embodiments of the present disclosure.

### DETAILED DESCRIPTION

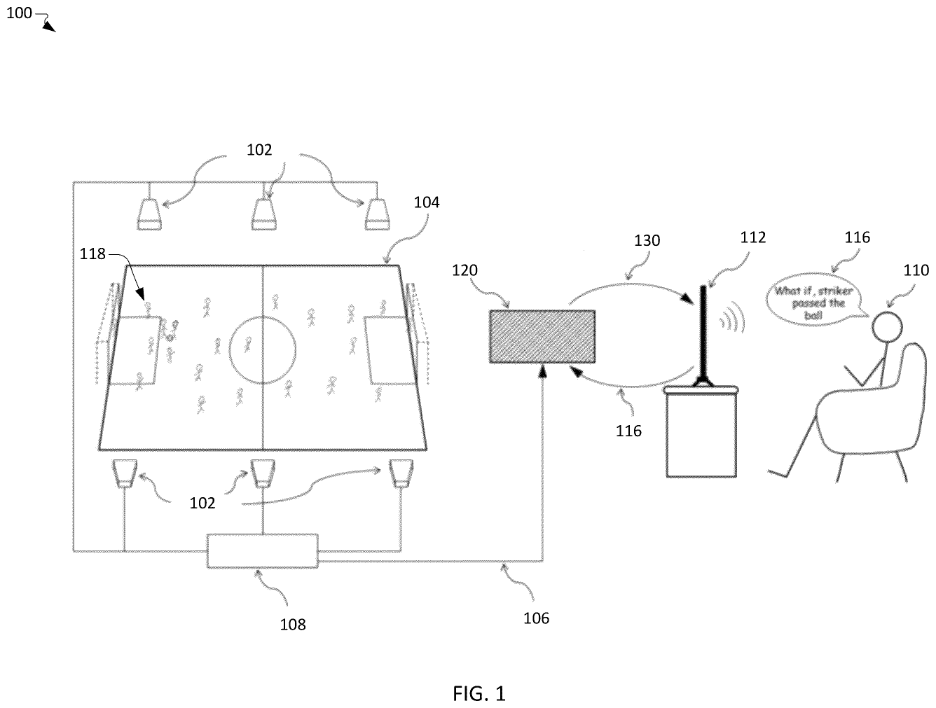

FIG. 1 through FIG. 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, the use of technology is transforming sports refereeing, analytics, and viewing. For example, the use of tracking and advanced visualization systems is increasing in various sports environments to track balls and players. These systems not only make on-field sports decision making less error-prone but also enable the sports analysts and broadcasters overlay various sports information and statistics in useful ways, thereby enhancing the experience for and increasing engagement of the viewers. However, visualization of “what if” scenarios, e.g., using an altered video feed, after each game may be particularly useful, though currently difficult to generate, as there are no systems to visualize and perceptually explore such alternative possible gameplays and outcomes.

Accordingly, the present disclosure provides systems and methods for generating alternate replays of highlights for outcome exploration. As described herein, the present disclosure includes an alternative replay generation system that receives input from one or more cameras of an entertainment system in the form of a video feed as well as a requested alteration prompt from an electronic device. The requested alteration prompt includes an alternate scenario to be generated using the video feed from the one or more cameras. The techniques described in the present disclosure use generative artificial intelligence and machine learning models, such as large language models (LLM), generative adversarial imitation learning, and large multi-modal generative models, to track balls and players and synthesize realistic alternative gameplay of selected sports moments based on user prompts.

FIG. 1 illustrates an example entertainment system 100 according to various embodiments of the present disclosure. The embodiment of the entertainment system 100 illustrated in FIG. 1 is for illustration only. However, entertainment systems come in a wide variety of configurations, and FIG. 1 does not limit the scope of this disclosure to any particular implementation of an entertainment system.

In an embodiment of this disclosure, the various components of an entertainment system 100 are shown in FIG. 1. The entertainment system 100 includes one or more cameras 102 that record a game on a field 104 from one or multiple perspectives and send video and tracking data 106 to a central video processing unit 108. The central video processing unit 108 may physically reside in the vicinity of the field 104, e.g., in a stadium, during recording. The central video processing unit 108 may employ computer vision (CV), machine learning (ML), or artificial intelligence (AI) techniques to track a position of target objects 118, e.g., players and balls, during the recording. The tracking techniques used by the central video processing unit 108 may include using active or passive markers on the target objects 118, e.g., on the ball and players, that aid in precise and improved real-time localization and tracking. FIG. 1 shows a plurality of target objects 118 in a field 104 with one or more cameras 102. The video and tracking data 106 from the one or more cameras 102, e.g., a set of videos from multiple angles, are transmitted to the central video processing unit 108 which broadcasts or streams the appropriate angle to an electronic device 112 of a user 110. The user 110 may view the video broadcast on a display of the electronic device 112. The central video processing unit 108 may transmit the video and tracking data 106 from only one of the one or more cameras 102, several of the one or more cameras 102, or all of the one or more cameras 102, e.g., only a single viewpoint or multiple viewpoints videos, to an alternative replay generation (ARG) system 120.

The ARG system 120 provides a natural interface by accepting voice and typed user prompts 116 in natural language. Based on the user prompt 116, the ARG system 120 processes a key moment, e.g., a sports highlight, of the recording to generate one or more alternate video feeds 130 of the one or more alternate possible outcomes using generative AI techniques and transmits the one or more alternate video feeds 130 to the electronic device 112 for the user 110 to watch. This general process is shown in FIG. 1. The ARG system 120 may be implemented remotely, e.g., in a cloud, on the edge network, or on the electronic device 112.

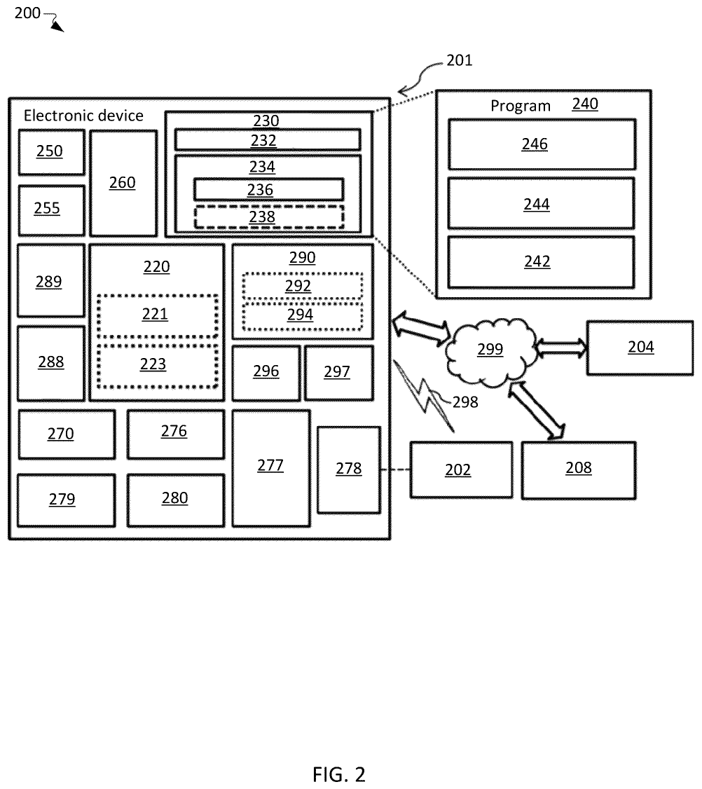

FIG. 2 is a block diagram illustrating an electronic device 201 in a network environment 200 according to various embodiments. Referring to FIG. 2, the electronic device 201 in the network environment 200 may communicate with an electronic device 202 via a first network 298 (e.g., a short-range wireless communication network), or an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, memory 230, an input device 250, a sound output device 255, a display device 260, an audio module 270, a sensor module 276, an interface 277, a haptic module 279, a camera module 280, a power management module 288, a battery 289, a communication module 290, a subscriber identification module (SIM) 296, or an antenna module 297. In some embodiments, at least one (e.g., the display device 260 or the camera module 280) of the components may be omitted from the electronic device 201, or one or more other components may be added in the electronic device 201. In some embodiments, some of the components may be implemented as single integrated circuitry. For example, the sensor module 276 (e.g., a fingerprint sensor, an iris sensor, or an illuminance sensor) may be implemented as embedded in the display device 260 (e.g., a display).

The processor 220 may execute, for example, software (e.g., a program 240) to control at least one other component (e.g., a hardware or software component) of the electronic device 201 coupled with the processor 220 and may perform various data processing or computation. According to one embodiment, as at least part of the data processing or computation, the processor 220 may load a command or data received from another component (e.g., the sensor module 276 or the communication module 290) in volatile memory 232, process the command or the data stored in the volatile memory 232, and store resulting data in non-volatile memory 234. According to an embodiment, the processor 220 may include a main processor 221 (e.g., a central processing unit (CPU) or an application processor (AP)), and an auxiliary processor 223 (e.g., a graphics processing unit (GPU), an image signal processor (ISP), a sensor hub processor, or a communication processor (CP)) that is operable independently from, or in conjunction with, the main processor 221. Additionally, or alternatively, the auxiliary processor 223 may be adapted to consume less power than the main processor 221, or to be specific to a specified function. The auxiliary processor 223 may be implemented as separate from, or as part of the main processor 221.

The auxiliary processor 223 may control at least some of functions or states related to at least one component (e.g., the display device 260, the sensor module 276, or the communication module 290) among the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 223.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234.

The program 240 may be stored in the memory 230 as software, and may include, for example, an operating system (OS) 242, middleware 244, or an application 246.

The input device 250 may receive a command or data to be used by another component (e.g., the processor 220) of the electronic device 201, from the outside (e.g., a user) of the electronic device 201. The input device 250 may include, for example, a microphone, a mouse, a keyboard, or a digital pen (e.g., a stylus pen).

The sound output device 255 may output sound signals to the outside of the electronic device 201. The sound output device 255 may include, for example, a speaker or a receiver. The speaker may be used for general purposes, such as playing multimedia or playing record, and the receiver may be used for an incoming call. According to an embodiment, the receiver may be implemented as separate from, or as part of the speaker.

The display device 260 may visually provide information to the outside (e.g., a user) of the electronic device 201. The display device 260 may include, for example, a display, a hologram device, or a projector and control circuitry to control a corresponding one of the display, hologram device, and projector. According to an embodiment, the display device 260 may include touch circuitry adapted to detect a touch, or sensor circuitry (e.g., a pressure sensor) adapted to measure the intensity of force incurred by the touch.

The audio module 270 may convert a sound into an electrical signal and vice versa. According to an embodiment, the audio module 270 may obtain the sound via the input device 250 or output the sound via the sound output device 255 or a headphone of an external electronic device (e.g., an electronic device 202) directly (e.g., wiredly) or wirelessly coupled with the electronic device 201.

The sensor module 276 may detect an operational state (e.g., power or temperature) of the electronic device 201 or an environmental state (e.g., a state of a user) external to the electronic device 201, and then generate an electrical signal or data value corresponding to the detected state. According to an embodiment, the sensor module 276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high-definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, a HDMI connector, a USB connector, a SD card connector, or an audio connector (e.g., a headphone connector).

The haptic module 279 may convert an electrical signal into a mechanical stimulus (e.g., a vibration or a movement) or electrical stimulus which may be recognized by a user via his tactile sensation or kinesthetic sensation. According to an embodiment, the haptic module 279 may include, for example, a motor, a piezoelectric element, or an electric stimulator.

The camera module 280 may capture a still image or moving images. According to an embodiment, the camera module 280 may include one or more lenses, image sensors, image signal processors, or flashes.

The power management module 288 may manage power supplied to the electronic device 201. According to one embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the application processor (AP)) and supports a direct (e.g., wired) communication or a wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device via the first network 298 (e.g., a short-range communication network, such as Bluetooth™, wireless-fidelity (Wi-Fi) direct, Ultra-WideBand (UWB), or infrared data association (IrDA)) or the second network 299 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 292 may identify and authenticate the electronic device 201 in a communication network, such as the first network 298 or the second network 299, using subscriber information (e.g., international mobile subscriber identity (IMSI)) stored in the subscriber identification module 296.

The antenna module 297 may transmit or receive a signal or power to or from the outside (e.g., the external electronic device) of the electronic device 201. According to an embodiment, the antenna module 297 may include an antenna including a radiating element composed of a conductive material or a conductive pattern formed in or on a substrate (e.g., PCB). According to an embodiment, the antenna module 297 may include a plurality of antennas. In such a case, at least one antenna appropriate for a communication scheme used in the communication network, such as the first network 298 or the second network 299, may be selected, for example, by the communication module 290 (e.g., the wireless communication module 292) from the plurality of antennas. The signal or the power may then be transmitted or received between the communication module 290 and the external electronic device via the selected at least one antenna. According to an embodiment, another component (e.g., a radio frequency integrated circuit (RFIC)) other than the radiating element may be additionally formed as part of the antenna module 297.

At least some of the above-described components may be coupled mutually and communicate signals (e.g., commands or data) there between via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 201 and the external electronic device 204 via the server 208 coupled with the second network 299. Each of the electronic devices 202 and 204 may be a device of a same type as, or a different type, from the electronic device 201. According to an embodiment, all or some of operations to be executed at the electronic device 201 may be executed at one or more of the external electronic devices 202 or 204. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 201. The electronic device 201 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 240) including one or more instructions that are stored in a storage medium (e.g., internal memory 236 or external memory 238) that is readable by a machine (e.g., the electronic device 201). For example, a processor (e.g., the processor 220) of the machine (e.g., the electronic device 201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium, e.g., compact disc read only memory (CD-ROM), or be distributed, e.g., downloaded or uploaded, online via an application store, or between two user devices directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively, or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

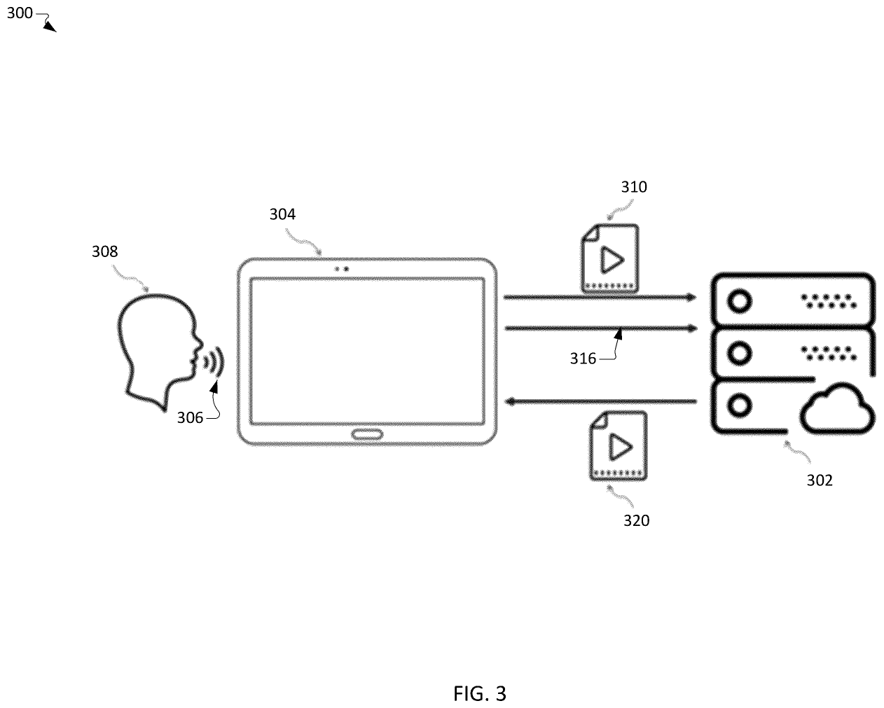

FIG. 3 illustrates an example ARG system 300 for use in an entertainment system according to various embodiments of the present disclosure. The ARG system 300 may be used as part of the entertainment system 100 of FIG. 1, e.g., as the ARG system 120, described above.

As shown in FIG. 3, the ARG system 300 may be split to perform complementary parts. The ARG system 300 may include a remote server 302 communicatively coupled to an electronic device 304 that is configured to receive a prompt 306 from a user 308. Upon receiving the prompt 306, the electronic device 304 may transmit an original clip 310, e.g., a selected subset of frames from a recording, and an embedded prompt 316 to a remote server 302 of the ARG system 300. The remote server 302 may perform video data processing and generative video processing based on the received original clip 310 and the embedded prompt 316 to generate an alternative video clip 320, e.g., a variation of the selected subset of frames from the recording where at least one of the original frames is replaced with a generated alternative frame. The remote server 302 may then transmit the generated alternative video clip 320 to the electronic device 304 for display to the user 308.

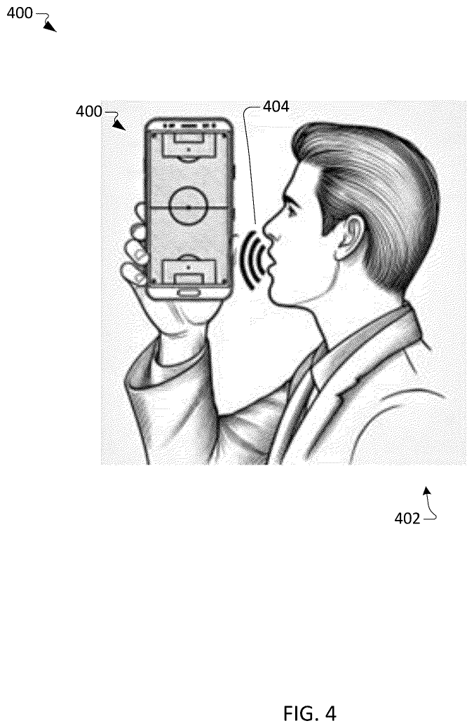

FIG. 4 illustrates an example electronic device 400 to support an entertainment system according to an embodiment of the present disclosure. For example, the electronic device 400 may be used with the entertainment system 100 of FIG. 1, e.g., as the electronic device 112, described above.

As shown in FIG. 4, a user 402 is interacting with the electronic device 400. For example, the user 402 may be providing a requested alteration prompt 404, e.g., a voice prompt, to the electronic device 400. The electronic device 400 may include, but not limited to, smart TVs, tablets, laptops, table-top video display devices, smartphones, and AR/VR/XR devices. The electronic device 400 may receive requested alteration prompts 404 from a user 402 in any desirable manner, including speech, text, and gestures. The requested alteration prompt 404, either as is or encoded to a common format, is provided as input to the ARG system 120. As shown in FIG. 4, the user 402 is viewing a recording or video feed, e.g., a soccer match replay, on the electronic device 400 and interacting with the ARG system 120 via an application operating on the electronic device 400.

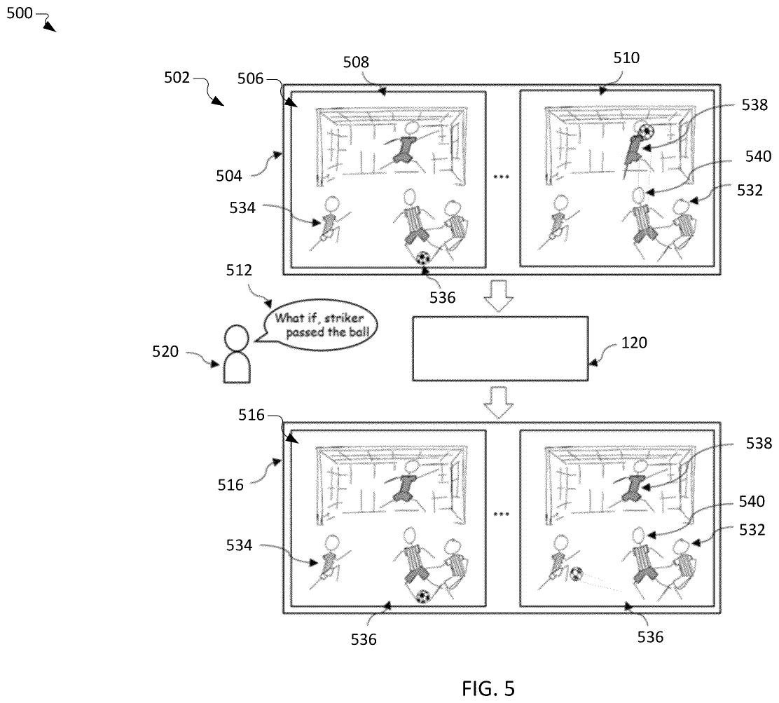

FIG. 5 illustrates an example input/output system 500 for an alternative replay generation system as part of an entertainment system according to various embodiments of this disclosure. For example, the input/output system 500 may be used with the ARG system 120 of FIG. 1. Although FIG. 5 is described in relation to the ARG system 120, it is understood that the input/output system 500 may be used with variations or alternative embodiments of the ARG system, such as the ARG system 300 of FIG. 3.

As shown in FIG. 5, the input/output system 500 is in communication with the ARG system 120 and may include a plurality of frames 502 of an original recording. For example, the plurality of frames 502 may depict a game-changing event of a soccer match. The input/output system provides input to the ARG system 120 in the form of a selected subset of frames 504 of the plurality of frames 502 demarked by the start frame 508 and the end frame 510, e.g., a beginning and an end of a game-highlight, replay, or key moment.

The input/output system 500 also provides a requested alteration prompt 512 from a user 520 to the ARG system 120. The requested alteration prompt 512 is used as a condition for a generated alternative replay video that is output from the ARG system 120. For example, and as shown in FIG. 5, the user 520 observes a key moment in a soccer game in which a first target 532, e.g., a first player, attempted to kick a third target 536, e.g., a ball, directly towards the opponent's goal but missed the opportunity because the fourth target 538, e.g., a goalkeeper, was able to stop the third target 536. The user 520 wonders what could have happened if the first target 532 would have passed the third target 536 to the unmarked second target 534 instead of shooting the third target 536 to the goal himself. The user 520 sends a requested alteration prompt 512 to the ARG system 120 via an electronic device, e.g., a smart TV, where the requested alteration prompt 512 requests a potential alternative outcome that includes the first target 532 passing the third target 536 to second target 534 rather than kicking the third target 536 to the goal directly. The ARG system 120 includes one or more multi-modal generative artificial intelligence foundational models with vision capabilities and fine-tuned for specific video generation. The inputs to the ARG system 120 include but are not limited to video, image, voice, text, and gesture data. The ARG system 120 analyzes the set of frames during the key moment and picks a point in the set of frames at which the first target 532 could have passed the third target 536 to second target 534 around a fourth target 540. Setting a point in time just before first target 532 kicked the third target 536 towards the goal as the starting point of simulation, and using a sequence of frames prior to the point as a brief history, the ARG system 120 uses a model fine-tuned for soccer-game-playing to proceed forward with the game for a short duration or until a significant event happens in the simulation (newly generated sequence of the game-play) Although the concept was illustrated using a soccer game as an example, the ARG system 120 is not limited to soccer games itself. Different game models may be used by the ARG system 120 to generate a plausible game play for a short duration given a starting point and a short history. The short history is a finite and short sequence of frames and events prior to the identified starting point. The history is used to condition the new sequence generation so that the outcome is a realistic and plausible alternative. Furthermore, all the different game models may not be stored in the ARG system 120 indefinitely. For example, the ARG system 120 may store a select number of models based on the user 520 preference and often watched games. Models for new games and new (updated) models for previously viewed games may be downloaded via network on an as-needed basis. The models may also be purchased from the model provider. Moreover, these models may be developed from a multimodal foundational model that is trained on massive datasets of images and videos of games, game commentary, text, video games, of different sports etc., allowing them to learn complex patterns and relationships. Furthermore, the foundational models may be fine-tuned for one or more specific sports. In general, these models have the capability to understand natural language, detect objects, people, and events in sports videos and generate new storylines.

In an embodiment of this disclosure, the ARG system 120 augments specialized models for realistic image and video generation along with the fine-tuned large multimodal foundational model to do specific tasks. Furthermore, the system also employs Retrieval-Augmented Generation or RAG to inject additional or side information to the AI system.

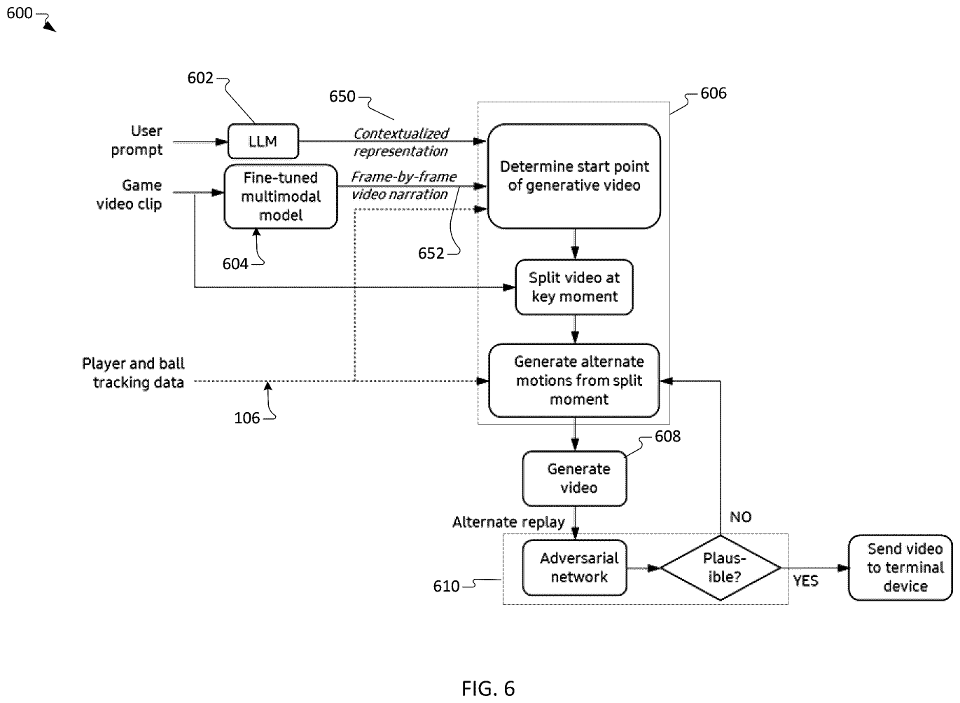

FIG. 6 illustrates an example high-level data flow and block diagram 600 of the ARG system 120 according to an embodiment of the present disclosure. The main inputs to the ARG system 120 are the requested alteration prompts 512 and the plurality of frames 502, e.g., a sports highlight or key moment, and may include the start frame 508 and the end frame 510. Alternatively, the plurality of frames 502 may include metadata that specifies the start and end timestamps of the plurality of frames 502. In operation 602, the requested alteration prompt 512 is processed by a large language model (LLM) to generate a contextualized representation 650 of the requested alteration prompt 512. In operation 604, a large multimodal model capable of analyzing images and providing textual representations is used to analyze the plurality of frames 502 to generate a frame-by-frame narration 652. For example, the large multimodal model may include natural language processing and visual processing. The large multimodal model may include vision capabilities fine-tuned for the specific sport is used to analyze the plurality of frames 502 to generate a frame-by-frame narration. The narration is a language-based temporal description of the events occurring in the sequence of a video frame. The large multimodal model is configured to generate succinct and accurate narration of the events relevant to the requested alteration prompt 512, e.g., the gameplay and task-at-hand, while ignoring the irrelevant or less-important parts of the scene in the plurality of frames 502.

In operation 606, the contextualized representation 650 of the requested alteration prompt 512 and the frame-by-frame narration 652 are used to select the subset of frames 504, e.g., to determine where to split the video. If tracking data 106 for the target objects 118 is available along with the plurality of frames 502, the tracking data 106 is also used to select the subset of frames 504. The subset of frames 504 may be selected using an artificial intelligence (AI) model that uses all data available, including the tracking data 106. Alternatively, two different AI models may be used, e.g., a first AI model that uses the tracking data 106 and a second AI model that does not incorporate the tracking data 106, to select the subset of frames 504 from the plurality of frames 502. The AI models may be retrieved by the service provider online based on the configuration of the entertainment system 100, e.g., based on the specific game and available data scenarios.

In operation 608, the subset of frames 504 are used to generate a new, fictitious-but-plausible video clip. A generative AI model for the video generation is trained according to a specific environment, e.g., for an ARG system 120 configured to generate sports replays based on a specific sport, the generative AI model would be trained using real replays of the specific sport. The generative AI model would generate physically plausible altered video feed 516 based on learned game movements. The altered video feed 516 are then appended with the plurality of frames 502, e.g., the first part of the real video or the portion of the real video before the split, to generate a complete altered video feed 516.

In operation 610, the complete altered video feed 516 may be inputted into and analyzed by an adversarial learning architecture or network to determine the plausibility of the altered video feed 516. For example, the adversarial network may assign a realness score based on the different movements of the target objects 118, e.g., players and objects, in the altered video feed 516. If the realness score is above a predetermined threshold, the altered video feed 516 is transmitted to the electronic device 112 and displayed to the user 520.

If the realness score is below the predetermined threshold, the ARG system 120 may discard the generated altered video feed 516 and generate a subsequent altered video feed. The adversarial network may be trained on a large dataset of video clips of the relevant environment, e.g., sports clips for an ARG system 120 configured to generate sports replays based on a specific sport, from real world and computer-generated clips with random or unrealistic movements of target objects 118 to identify real, plausible movements from unrealistic and random movements.

In some implementations, the tracking data 106 of the target objects 118 is generated using an ML-based video-to-skeleton network that aids with improved decision making on the point of splitting and also on the realness score of the altered video feed 516.

In addition to the altered video feed 516 of probable game play, the ARG system 120 may also generate other relevant information and visualizations which may be overlaid on the altered video feed 516. For example, in an embodiment where the ARG system 120 is configured to generate sports replays, the ARG system 120 may include an altered video feed 516 that includes a path or trajectory of a ball that is highlighted through the entire sequence of the altered video feed 516.

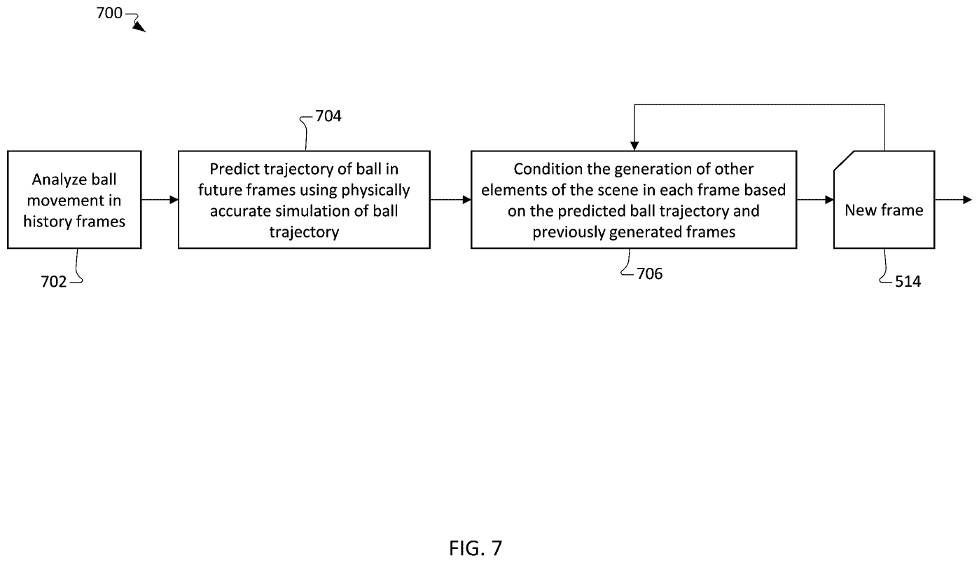

FIG. 7 illustrates an example high-level data flow and block diagram of a multi-object tracking model 700 used to support the ARG system 120 according to an embodiment of the present disclosure. For example, the multi-object tracking model 700 may include a tracking module 702 that first tracks the motion of a target object such as the third target 536, e.g., a ball or badminton shuttle, in the plurality of frames 502. A prediction module 704 then predicts the future trajectory of the third target 536 from the identified starting point, e.g., in the selected subset of frames 504, based on an accurate physics-based model. Following the determination of the third target 536 in each frame, other elements of the scene in each frame, e.g., movements of the first target 532 and the second target 534, are generated in a generation module 706 that may use the overall architecture shown in FIG. 5.

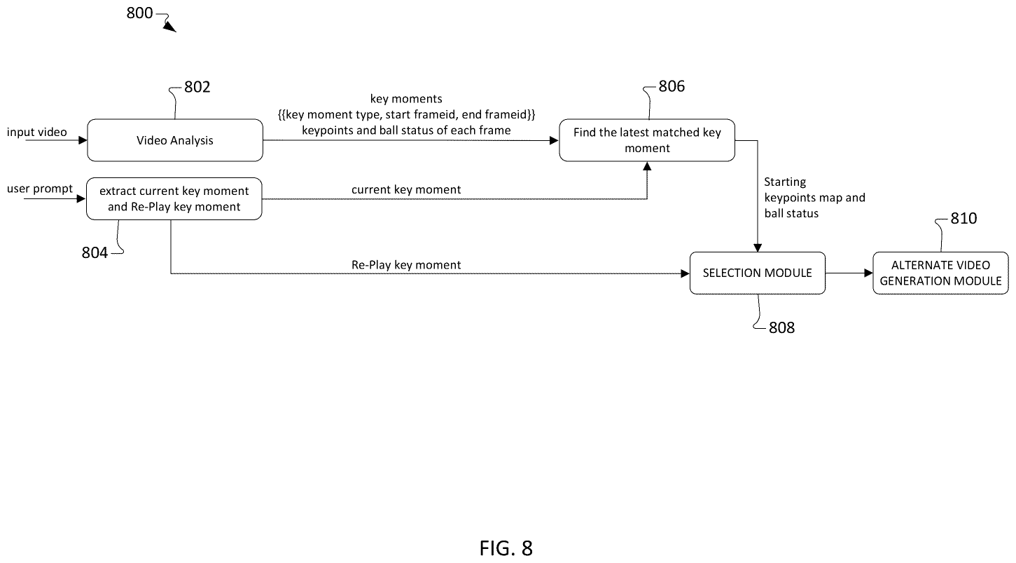

FIG. 8 illustrates an example high-level data flow and block diagram 800 of an ARG system 120 according to an embodiment of the present disclosure. In particular, the block diagram 800 may be performed by the entertainment system 100 of FIG. 1 and use the input/output system 500 of FIG. 5.

As shown in FIG. 8, the block diagram 800 includes a video analysis module 802, prompt parser module 804, a frame selection module 808, and an alternate video generation module 810. The video analysis module 802 parses the input video to extract key moments, e.g. shooting or passing, and their start time, e.g., using a frame ID, and end time, e.g., using a frame ID, track the motion and position per frame of the target objects 118, e.g., of the players, and track the status of another target object 118, e.g., a ball, per frame. The video analysis module 802 may use generative AI tools to extract the key moments and other advanced AI-based solutions to tracking the athletes and ball.

The prompt parser module 804 is configured to decipher the intention of the user by using audio, text, and gesture inputs. The prompt parser module 804 extracts the “current key moment” which is to be replaced in the video feed, e.g., the at least one original frame 506 to be replaced by the at least one alternate frame 514, and also the “replay key moment” which is the alternative moment requested by user, e.g., a scenario requested by the requested alteration prompt 512 to be depicted in the altered video feed 516. The “current key moment” is used in an input combination module 806 to match with the key moments set obtained from the video analysis module 802. The beginning of the corresponding key moment is identified and also the starting keypoints map and target object 118 status. Then, the starting status and the “re-play key moment” are input to the frame selection module 808.

The frame selection module 808 generates a keypoints video of the players and the ball path based on the starting status and the “re-play key moment”. The frame selection module 808 can be trained on a large dataset and improved using the Generative Adversarial Network (GAN).

The alternate video generation module 810 generates an alternative video clip, e.g., the altered video feed 516 from the keypoints video and ball path to ARG system 120. A GAN may also be used to train the alternate video generation module 810.

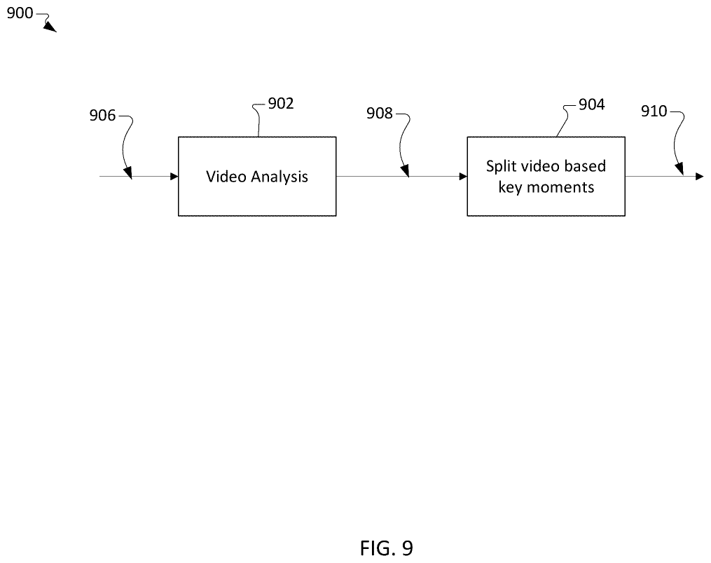

FIG. 9 illustrates an example training model block diagram 900 used to support an ARG system 120 according to an embodiment of the present disclosure. In particular, the training model block diagram 900 may be used to train modules of the block diagram 800 of FIG. 8.

As shown in FIG. 9, the training model block diagram 900 includes a video analysis module 902 and a video split module 904. The video analysis module 902 is used to generate the training dataset by analyzing a large sports dataset 906 as input, sending a plurality of training frames 908 to the video split module 904. The video split module 904 then selects a subset of training frames 910. The training dataset, e.g., the subset of training frames 910, is then used to train a frame selection module, e.g., the frame selection module 808, and an alternate video generation module, e.g., the alternate video generation module 810.

Additionally, virtual agents and virtual gaming and simulation environments may be used to generate videos and tracking data for training the frame selection module and alternate video generation modules.

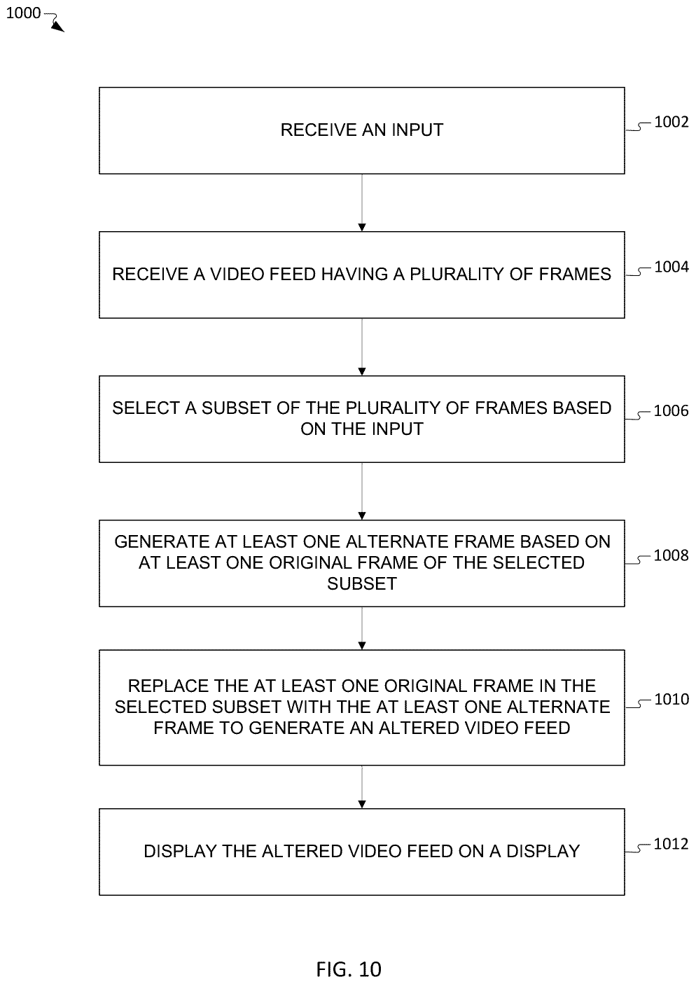

FIG. 10 illustrates an example flow chart of a method 1000 of generating an altered video feed according to various embodiments of the present disclosure. For example, the method 1000 may be performed by the entertainment system 100 of FIG. 1 using the input/output system 500 of FIG. 5.

The method 1000 includes receiving an input in operation 1002 at an ARG system, e.g., the ARG system 120. The input may be a requested alteration prompt 512 given by a user 520 and transmitted using an electronic device 112. Receiving the input includes determining a requested selected subset of frames 504 using a prompt parser module 804.

In operation 1004, a video feed having a plurality of frames 502 is received, e.g., by the ARG system 120, that may depict a scene in an environment, e.g., a video or clip of a sports game. The video feed and the plurality of frames 502 may be transmitted by one or more cameras 102 of an entertainment system 100 to the ARG system 120. For example, receiving a video feed includes using a multimodal language model to generate a frame-by-frame narration for the plurality of frames 502. Additionally, receiving an input includes using a large language model to provide contextualized representation corresponding to the frame-by-frame narration. Receiving the video feed may also include extracting a plurality of selected subset of frames 504 from the plurality of frames 502 using a large language model, identifying a target object 118 status in each frame of the selected subset of frames 504, and generating a multi-object tracking model, e.g., the multi-object tracking model 700 of FIG. 7.

In operation 1006, a subset of frames 504 of the plurality of frames 502 is selected based on the input received in operation 1002. For example, selecting a subset of frames 504 of the plurality of frames 502 based on the input includes selecting a selected subset of frames 504 of the plurality of frames 502 that matches the requested alteration prompt 512 received in the input.

In operation 1008, at least one alternate frame 514 is generated, e.g., using the ARG system 120, based on at least one original frame 506 of the selected subset of frames 504 of the plurality of frames 502. For example, the ARG system 120 may generate the at least one alternate frame 514 based on the at least one original frame 506 of the selected subset of frames 504 by analyzing a movement of a target object 118 in a scene of the at least one original frame 506. The ARG system 120 may then predict a future trajectory of the target object 118. The ARG system 120 may then generate other elements of the scene based on the future trajectory of the target object 118 and previously-generated alternate frames of the at least one alternate frame 514. In another example, the ARG system 120 may generate at least one alternate frame 514 based on at least one original frame 506 of the selected subset of frames 504 includes receiving a requested alteration prompt 512 from the prompt parser module 804 based on the input then generate the at least one frame of a target object 118 and other elements of a scene in the selected subset of frames 504 to match the requested alteration prompt 512.

In operation 1010, the at least one original frame 506 is replaced in the selected subset of frames 504 with the at least one alternate frame 514 to generate an altered video feed 516. The altered video feed 516 may be optionally processed through an adversarial network to verify plausibility of the scene depicted by the altered video feed 516, as described above. In operation 1012, the altered video feed 516 is displayed on an electronic device 112.

The present disclosure provides for a systems and methods that provide physically plausible alternative video feed generated based on a scene in an original or “real” video feed and a prompt by a user. The present disclosure generates visualizations to aid in “what if” scenario analysis and exploration of alternative possibilities in a recorded scene that are realistic.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A computer-implemented method comprising:
receiving an input;
receiving a video feed comprising a plurality of frames;
selecting a subset of the plurality of frames based on the input;
generating at least one alternate frame based on at least one original frame of the selected subset;
replacing the at least one original frame in the selected subset with the at least one alternate frame to generate an altered video feed; and
displaying the altered video feed on a display.

2. The method of claim 1, wherein receiving a video feed comprises using a multimodal language model to generate a frame-by-frame narration and wherein receiving an input comprises using a large language model to provide contextualized representation corresponding to the frame-by-frame narration.

3. The method of claim 1, further comprising inputting the altered video feed into an adversarial learning architecture configured to determine a plausibility of the altered video feed.

4. The method of claim 1, wherein generating the at least one alternate frame based on the at least one original frame of the subset comprises:
analyzing a movement of a target object in a scene of the at least one original frame;
predicting a future trajectory of the target object; and
generating other elements of the scene based on the future trajectory of the target object and previously-generated alternate frames of the at least one alternate frame.

5. The method of claim 1, wherein receiving the video feed comprising the plurality of frames comprises:
selecting a subset of frames from the plurality of frames using a large language model;
identifying a status of a target object in each frame of the selected subsets of frames; and
generating a multi-object tracking model, and wherein receiving the input comprises determining a requested selected subset of frames using a prompt parser module.

6. The method of claim 5, wherein selecting a subset of frames of the plurality of frames based on the input comprises selecting a subset of frames of the plurality of frames of the video feed that matches a requested subset of frames of the input.

7. The method of claim 6, wherein generating at least one alternate frame based on at least one original frame of the selected subset comprises receiving a requested alteration prompt from the prompt parser module based on the input and generating the at least one alternate frame of a target object and other elements of a scene in the selected subset to match the requested alteration prompt.

8. An alternative replay generation system, comprising:
an electronic device comprising a processor, the processor configured to cause the electronic device to:
receive an input;
receive a video feed comprising a plurality of frames;
select a subset of the plurality of frames based on the input;
generate at least one alternate frame based on at least one original frame of the selected subset;
replace the at least one original frame in the selected subset with the at least one alternate frame to generate an altered video feed; and
transmit the altered video feed to a display.

9. The alternative replay generation system of claim 8, wherein the processor, when causing the electronic device to receive a video feed, is further configured to cause the electronic device to use a multimodal language model to generate a frame-by-frame narration and, when causing the electronic device to receiving an input, is further configured to cause the electronic device to use a large language model to provide contextualized representation corresponding to the frame-by-frame narration.

10. The alternative replay generation system of claim 8, wherein the processor is further configured to cause the electronic device to input the altered video feed into an adversarial learning architecture configured to determine a plausibility of the altered video feed.

11. The alternative replay generation system of claim 8, wherein the processor, when causing the electronic device to generate the at least one alternate frame based on the at least one original frame of the subset, is configured to cause the electronic device to:
analyze a movement of a target object in a scene of the at least one original frame;
predict a future trajectory of the target object; and
generate other elements of the scene based on the future trajectory of the target object and previously-generated alternate frames of the at least one alternate frame.

12. The alternative replay generation system of claim 8, wherein the processor, when causing the electronic device to receive a video feed, is further configured to cause the electronic device to:
select a subset of frames from the plurality of frames using a large language model;
identify a status of a target object in each frame of the selected subsets of frames; and
generate a multi-object tracking model.

13. The alternative replay generation system of claim 12, wherein the processor, when causing the electronic device to receive the input, is further configured to cause the electronic device to determine a requested subset of frames using a prompt parser module.

14. The alternative replay generation system of claim 13, wherein the processor, when causing the electronic device to generate at least one alternate frame based on at least one original frame of the selected subset, is further configured to cause the electronic device to:
receive a requested alteration prompt from the prompt parser module based on the input; and
generate the at least one alternate frame of a target object and other elements of a scene in the selected subset to match the requested alteration prompt.

15. A non-transitory computer-readable medium comprising program code, that when executed by at least one processor of an electronic device, causes the electronic device to:
receive an input;
receive a video feed comprising a plurality of frames;
select a subset of the plurality of frames based on the input;
generate at least one alternate frame based on at least one original frame of the selected subset;
replace the at least one original frame in the selected subset with the at least one alternate frame to generate an altered video feed; and
transmit the altered video feed to a display.

16. The non-transitory computer-readable medium of claim 15, wherein the program code, that when executed by the at least one processor, causes the electronic device to generate the at least one alternate frame based on the at least one original frame of the subset, comprises program code, that when executed by the at least one processor, causes the electronic device to receiving a requested alteration prompt from a prompt parser module based on the input and generating the at least one alternate frame of a target object and other elements of a scene in the selected subset to match the requested alteration prompt.

17. The non-transitory computer-readable medium of claim 15, wherein the program code, that when executed by the at least one processor, causes the electronic device to receive a video feed, comprises program code, that when executed by the at least one processor, causes the electronic device to use a multimodal language model to generate a frame-by-frame narration and, when causing the electronic device to receiving an input, is further configured to cause the electronic device to use a large language model to provide contextualized representation corresponding to the frame-by-frame narration.

18. The non-transitory computer-readable medium of claim 15, further comprising program code, that when executed by the at least one processor, causes the electronic device to input the altered video feed into an adversarial learning architecture configured to determine a plausibility of the altered video feed.

19. The non-transitory computer-readable medium of claim 18, wherein the program code, that when executed by the at least one processor, causes the electronic device to generate the at least one alternate frame based on the at least one original frame of the subset, comprises program code, that when executed by the at least one processor, causes the electronic device to:
analyze a movement of a target object in a scene of the at least one original frame;
predict a future trajectory of the target object; and
generate other elements of the scene based on the future trajectory of the target object and previously-generated alternate frames of the at least one alternate frame.

20. The non-transitory computer-readable medium of claim 19, wherein the program code, that when executed by the at least one processor, causes the electronic device to receive a video feed, comprises program code, that when executed by the at least one processor, causes the electronic device to:
select a subsets of frames from the plurality of frames using a large language model;
identify a status of a target object in each frame of the selected subsets of frames; and
generate a multi-object tracking model.
